(19) United States
(12) Patent Application Publication
(10) Pub. No.: US 2012/0084141 A1
(43) Pub. Date: Apr. 5, 2012

(54) System and Method to Predict the Performance of Keywords for Advertising Campaigns Managed on the Internet

(75) Inventors: Patrick Quinn, Gatineau (CA); Sandrine Paroz, Saint-Constant (CA); Richard Couture, Saint-Lambert (CA); Marc Poirier, Saint-Lambert (CA)

(73) Assignee: Acquisio, Saint -Lambert (CA)

(21) Appl. No.: 13/316,854

(22) Filed: Dec. 12, 2011

Related U.S. Application Data
(63) Continuation-in-part of application No. 12/780,352, filed on May 14, 2010.

(30) Foreign Application Priority Data
Mar. 30, 2009 (CA) 2659538

(51) Int. Cl. G06Q 30/02

(52) U.S. Cl. 705/14.43

(57) ABSTRACT

Historical data from keywords in a pay-per-click internet advertising campaign are used to predict performance of other keywords with the goal of optimizing a keyword portfolio to maximize returns from the advertising campaign. A computing system receives the keyword portfolio for the advertising campaign, and classifies the keywords based on whether or not sufficient historical data exist to generate acceptable predictions about the performance of the keywords in the advertising campaign. Historical data are then used to make performance predictions for keywords having sufficient data. For keywords without sufficient historical data, generic prediction functions are created based on a generic change rate obtained from keywords with sufficient historical data. These generic prediction functions are then used to predict keyword performance in the advertising campaign. Predictions for keywords with and without sufficient historical data are then used to optimize the advertising campaign.

### CROSS-REFERENCE TO RELATED APPLICATIONS

This application is a continuation-in-part of U.S. patent application Ser. No. 12/780,352 filed on Mar. 30, 2010, published on May 26, 2011 as U.S. 2011/0125590, and entitled “System and Method For Managing and Optimizing Advertising Campaigns Managed on the Internet” which claims priority to Canadian Patent Application No. 2,659,538 filed on Mar. 30, 2009 and entitled “System and Method for Managing and Optimizing Advertising Networks,” both of which are incorporated herein by reference in their entirety.

### BACKGROUND OF THE INVENTION

1. Field of the Invention

The present invention relates generally to internet advertising networks, and more particularly, to managing advertising campaigns for internet advertising networks.

2. Description of the Prior Art

As the number of worldwide internet users grows, advertisers seeking to promote their products and services are turning more and more frequently towards search engine marketing. Major search engines offer various publicity channels in which advertisers can display several types of advertisements (hereinafter “ads”) on search engine results pages. These ads can be found in the form of texts, banners or even videos. Depending on the type of ad, advertisers will either be charged as a function of the number of times their ad is shown or the number of times the ad is accessed (e.g., the number of times the ad link is clicked). In 2009, the sum of revenues generated by the four major search engines (GOOGLE®, YAHOO!®, BAIDU®, and BING™) exceeded 37 billion U.S. dollars, with the search engines posting annual revenues of billions of US dollars. Advertiser interact marketing campaigns produced most of these revenues. For instance, GOOGLE® attributes the majority of its total 2007 and 2008 revenues to income from advertisers paying to use the GOOGLE® publicity networks.

One of the search engines' most lucrative publicity channels is the sponsored search network, where advertiser text ads are shown on the result pages of user search queries. Sponsored search advertising has become increasingly popular over the past few years. Several advantages distinguish it from other Web publicity channels and traditional marketing mediums such as television, radio and newspaper ads. Firstly, it allows the advertisers to target specific audiences by choosing exactly which keywords they wish to associate with their products or services, as well as which geographic locations they want to consider. When the keywords forming a campaign are carefully selected, ads are mostly shown to users who represent real potential customers and are truly interested in the product or service offered. Secondly, sponsored search campaigns are accessible to all types of businesses because advertisers have the liberty of deciding exactly how much they are willing to pay for each click by a user on the ad (hereinafter, “click”). Large businesses with high profit margins might be willing to pay more for each click, whereas smaller businesses with tow profit margins (and therefore presumably unable to pay as much for each click) could still benefit by setting tower bid values. Marketing campaigns can remain profitable as long as the bid values are tower than the expected profit per click (which profit per click can be calculated in the presence of sufficient historical data). Thirdly, this type of advertising is attractive to marketers because they only pay for customers who are directed to their website, so an exact profit figure can easily be attributed to each portion of a marketing campaign.

An auction mechanism used to sell ad space on search results pages requires that, for each possible query, advertisers compete in auctions to determine the order in which the ads will be presented. FIG. 1 shows an example of ten ads that have been obtained based on the query “cars for sale” in GOOGLE®. The ad positions are numbered sequentially, from the top (position 1) to the bottom of the list (position 10).

Studies have shown that higher ad positions (e.g., closer to position 1) have greater visibility and generate significantly higher numbers of clicks than lower positions (near the bottom of the list). Agarwal, A., Hosanagar. K., & Smith, M. D. (2008). Location, Location, Location: An Analysis of Profitability of Position in Online Advertising Markets (56), Pittsburgh: Heinz Research. To allocate ad positions among marketers, search engines auction ad positions, and advertisers compete for ad positions for specific queries. The goal of the auction is to assign a position to all of the advertisers competing for a specific query, based on the amount each advertiser is wilting to pay for each click (a “bid”). Search engines use sophisticated ranking algorithms that take into account advertisers' bids as well as their text ad and website relevance to determine how the ads should be placed in the list. More specifically, advertiser bids are weighted by a relevance score that is assigned by the search engine. The weighted bid values are then sorted in decreasing order. Once a ranking is established, the exact amount the advertisers must pay for each click is calculated using a generalized second-price algorithm whereby the cost per click (CPC) for each advertiser corresponds in general to the minimal value allowing that advertiser to remain higher than the nearest competitor below in the ranking.

Clicks, CPC and bids are negatively correlated with the ad position. Thus, for any given keyword, clicks, CPC, and bids generally decrease as the ad position falls (i.e., the ad position number gets larger). Consequently, advertisers managing their ad campaigns need to balance obtaining a high number of clicks at a high CPC against Obtaining a tow number of clicks at a low CPC. Finding a keyword's optimal bid value is not always easy because if the bid is too high, the campaign may become unprofitable, whereas if the bid value is too low, the campaign will not generate enough volume.

FIG. 2 details exemplary performance estimations across 10 ad positions for one specific keyword to show how each position can generate different profitability levels for the specific keyword. By assuming that each ad conversion (e.g. subscription, membership, sale, or other similar event by which the advertiser recoups revenue as a result of a user clicking on an ad link) is worth $30 to the advertiser (a value which will vary from one business to another) and that the conversion rate is constant from one position to another, one can estimate the performance of every position. In this example, position 6 offers the best balance between click volume and cost, yielding the highest expected net profits. As with the majority of keywords, the data from this example clearly show how ad positioning can influence the efficiency of a campaign.

This example suggests that the corresponding click, CPC, and bid values are known for each possible position. If this were the case, optimizing a campaign's performance would be relatively simple. The reality, however, is that advertisers do not know exactly how many clicks their ads would receive in each position, how much these clicks would cost, or even how much they should bid to reach their targeted cost-benefit position. The advertisers must instead predict these values based on their historical data, which presents a challenge in and of itself. The assumptions of constant profit per conversion and constant conversion rates per position can also generate some uncertainty. In fact, conversions occur very rarely in most types of business, with typical conversion rates range between 1% and 4%, which means that about 25 to 100 clicks are required in order to obtain a conversion. In light of such low conversion volumes, the average profit associated with a conversion and the average conversion rate of a keyword for each position can be difficult to determine.

To further complicate matters, sponsored search campaigns typically comprise several thousand keywords. Advertisers usually try to bid on all the keywords they judge to be relevant to their business. For example, a company selling shoes would want to bid on keywords such as “shoes”, “buy shoes”, “shop shoes”, “running shoes”, “tennis shoes”, “basketball shoes” and many others. With multiple combinations of verbs, adjectives and nouns, as well as many misspellings and singular/plural forms possible, campaign portfolios can contain incredibly high numbers of keywords.

Given this complexity, a tool which can automatically determine the bid for the ad or keyword is desirable for advertisers managing interact advertising campaigns so that these advertisers can optimize a marketer's campaigns globally within some defined Objectives and constraints. Such an automatic tool with the ability to predict with some success the performance of the keyword(s) or the ad(s) depending on predefined criteria (e.g., the ad position on the search engine) would be especially desirable.

### SUMMARY

In one embodiment is a method to predict performance of keywords in an internet pay-per-click advertising campaign comprising: receiving at a computing system a portfolio of keywords from a user computing device across a network; receiving at the computing system prior performance data for keywords in the portfolio; identifying a first set of portfolio keywords lacking sufficient prior performance data to be able to predict future performance of the first set of portfolio keywords; accessing at the computing system a dictionary of keywords and prior performance data for keywords in the dictionary, each dictionary keyword having sufficient prior performance data to be able to predict future performance of the dictionary keyword; generating prediction functions based on the accessed dictionary of keywords with sufficient prior performance data, each prediction function having a change rate; predicting the performance of the first set of portfolio keywords lacking sufficient prior performance data, the performance prediction being, based on the change rates of the prediction functions for the accessed dictionary of keywords with sufficient prior performance data; and transmitting the performance prediction across the network to the user computing device,

In another embodiment is the method further comprising: identifying a second set of portfolio keywords having sufficient prior performance data to be able to predict future performance of the second set of portfolio keywords; generating prediction functions based on the second set of portfolio keywords with sufficient prior performance data; predicting the performance of one or more keyword in the second set of portfolio keywords with sufficient prior performance data, the performance prediction being based on the prediction functions for the one or more keyword in the second set of portfolio keywords with sufficient prior performance data; and transmitting the performance prediction for the one or more keyword across the network to the user computing device,

In yet another embodiment is a system for predicting keyword performance in an internet pay-per-click advertising campaign comprising; a computing system configured to communicate over a network with a user computing device to obtain a keyword portfolio; communicate over the network to obtain past performance data for the keywords in the portfolio; identify a first set of portfolio keywords lacking sufficient prior performance data to be able to predict future performance of the first set of portfolio keywords; access a dictionary of keywords and prior performance data for the keywords in the dictionary, each dictionary keyword having sufficient prior performance data to be able to predict future performance of the dictionary keyword; generate prediction functions based on the accessed dictionary of portfolio keywords with sufficient prior performance data, each prediction function having a change rate; predict the performance of the first set of portfolio keywords lacking sufficient prior performance data, the performance prediction being based on the change rates of the prediction functions for the accessed dictionary of keywords with sufficient prior performance data; and transmit the performance prediction across the network to the user computing device.

In still another embodiment, the computing system is further configured to identify a second set of portfolio keywords having sufficient prior performance data to be able to predict future performance of the second set of portfolio keywords; generate prediction functions based on the second set of portfolio keywords with sufficient prior performance data; predict the performance of the second set of portfolio keywords with sufficient prior performance data, the performance prediction being based on the prediction functions for the second set of portfolio keywords with sufficient prior performance data; and transmit the performance prediction for the one or more keyword across the network to the user computing device.

In another embodiment is a non-transitory computer readable medium having stored thereupon computing instructions comprising: a code segment to receive at a computing system a portfolio of keywords from a user computing device across a network; a code segment to receive at the computing system prior performance data for keywords in the portfolio; a code segment to identify a first set of portfolio keywords lacking sufficient prior performance data to be able to predict future performance of the first set of portfolio keywords; a code segment to access at the computing system a dictionary of keywords and prior performance data for the keywords in the dictionary, each dictionary keyword having sufficient prior performance data to be able to predict future performance of the dictionary keyword; a code segment to generate prediction functions based on the accessed dictionary of portfolio keywords with sufficient prior performance data, each prediction function having a change rate; a code segment to predict the performance of the first set of portfolio keywords lacking sufficient prior performance data, the performance prediction being based on the change rates of the prediction functions for the accessed dictionary of keywords with sufficient prior performance data; and a code segment to transmit the performance prediction across the network to the user computing device,

In another embodiment, the non-transitory computer readable medium further has stored thereupon computing instructions comprising: a code segment to identify a second set of portfolio keywords having sufficient performance data to be able to predict future performance of the second set of portfolio keywords; a code segment to generate prediction functions based on the second set of portfolio keywords with sufficient prior performance data; a code segment to predict the performance of the second set of portfolio keywords with sufficient prior performance data, the performance prediction being based on the prediction functions for the second set of portfolio keywords with sufficient prior performance data; and a code segment to transmit the performance prediction for the one or more keyword across the network to the user computing device.

### BRIEF DESCRIPTION OF DRAWINGS

FIG. 1 shows a sample prior art query results page obtained from a GOOGLE® search using the terms “cars for sale”.

FIG. 2 details exemplary performance estimations for 10 ad positions using one specific keyword.

FIG. 3 is a block diagram of one embodiment of a system for predicting the performance of keywords for advertising campaigns managed on the internet.

FIG. 4 is a representative process flow detailing keyword classification according to one embodiment,

FIG. 5 is a representative process flow detailing how a generic change rate is calculated according to one embodiment.

FIG. 6 is a representative process flow detailing how a generic prediction function can be used to predict keyword performance according to one embodiment.

### DETAILED DESCRIPTION OF THE INVENTION

In pay-per-click search marketing, a number of metrics can define a marketing strategy and reflect an advertising campaign's performance for a given portfolio of keywords. One of the main parameters that need to be set precisely in order to optimize the campaign is the average CPC or maximum CPC of each keyword, either of which can define the maximum bid an advertiser would pay when someone clicks on the ad.

In the optimization model discussed herein, the goal is to maximize the number of clicks each ad within a campaign receives without exceeding a daily budget. This goal is achieved by optimizing the average CPC (and/or maximum CPC) of each keyword. The number of clicks each ad receives is tightly linked to the position at which the ad appears on the search engine's result page: the higher position in which the ad appears, the more clicks it receives. As a result, the ad position is also closely tied to the average CPC paid (and maximum CPC set) for the keyword corresponding to the ad.

Finding the relationship between, on the one hand, the number of clicks and the ad position, and on the other hand, the ad position and the average CPC (or maximum CPC) is one way to determine precisely how much to pay (i.e., the average CPC or maximum CPC) in order to attain the desired position on the results page, and in turn, the desired number of clicks. The generic curves described herein do precisely that: they describe the link between the advertiser-determined CPC and the number of clicks the advertiser can expect to receive in return.

Generating accurate predictions about new keywords/new ads or about keywords/ads that have held a stagnant position on a search engine over a predefined period of time is difficult because little, if any, historical data are available on which to base the predictions. The various embodiments of the system and method discussed herein provide a tool to make predictions for these data-sparse keywords/ads using data history (if available) or by using search engine-provided tools. The embodiments discussed herein allow advertisers to classify keywords from pay-per-click advertising campaigns according to data about the past performance of keywords (e.g., as positioned keywords) to calculate generic functions to predict and optimize the future performance (e.g., positioning) of the same or similar keywords in pay-per-click ad campaigns in a way that allows optimization of global goals against global constraints.

These tailored predictions offer advertisers the ability to plan and manage marketing campaigns that are more cost-effective than campaigns based on rule-based decision making processes as currently used by advertisers.

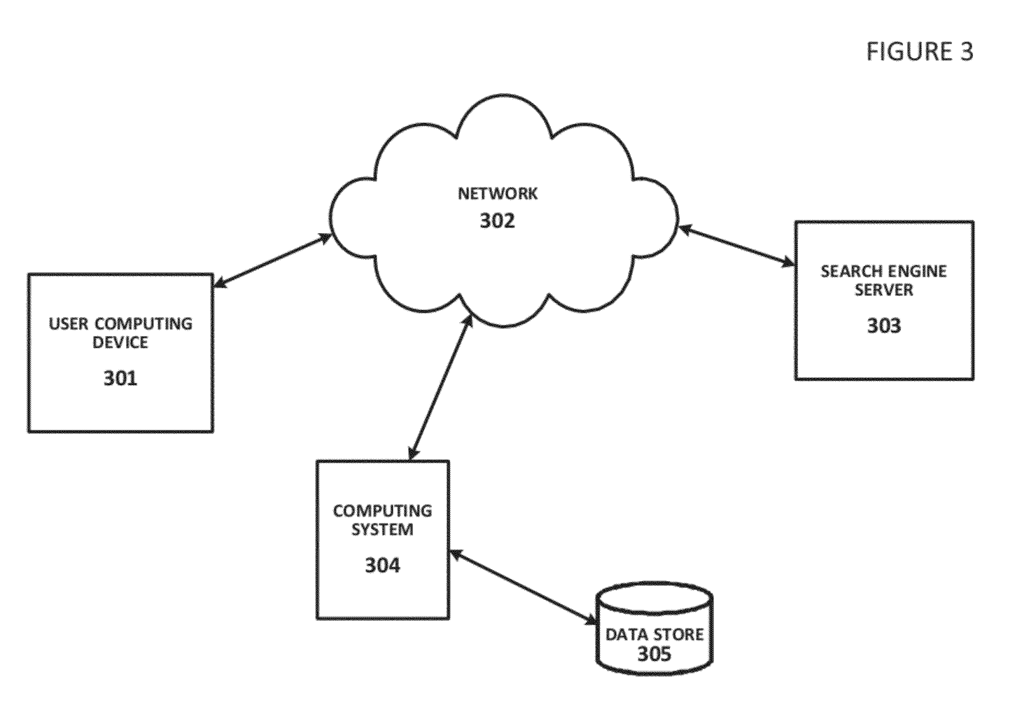

FIG. 3 is a block diagram of one embodiment of the performance prediction system described herein to predict the future performance and behavior of keywords. A computing system 304 (preferably a server) is coupled through a computing network 302 to a user computing device 301 and a search engine server 303. Computing system 304 is optionally coupled to a data store 305, either directly or through network 302. One of skill in the art will understand that computing system 304 can run on one or more physical machine, one or more software module, or on cloud-computing services, and that the optimization process can leverage a single server or multi-server infrastructure to provide the fastest response time. One of ordinary skill in the art will further understand that network 302 can be the internet, a wide area network (WAN), a local area network (LAN), a global area network (GAN), a virtual private network (VPN), a personal area network (PAN), an enterprise private network, or any similar network now known or later developed.

Use of the prediction system is initiated by a user request communicated from user computing device 301 through network 302 to computing system 304. After receiving a request, computing system 304 retrieves historical data from user computing device 301, search engine server 303, and/or data store 305 and then processes those data to predict performance of keywords based on historical data (for key words with sufficient historical data) and based on generic prediction functions (for keywords with insufficient historical data), as discussed below. Historical data are preferably from the advertiser's marketing campaign being optimized rather than from other marketing campaigns of that advertiser or from other advertisers' marketing campaigns.

Prediction of keyword performance is a multi-step process. First, several parameters are set: the portfolio of keywords (i.e., the keywords to be predicted), the metrics to be predicted (i.e., the dependent variables to be predicted from which independent variables), and the type of regressions to be performed (linear, linearized exponential, or exponential),

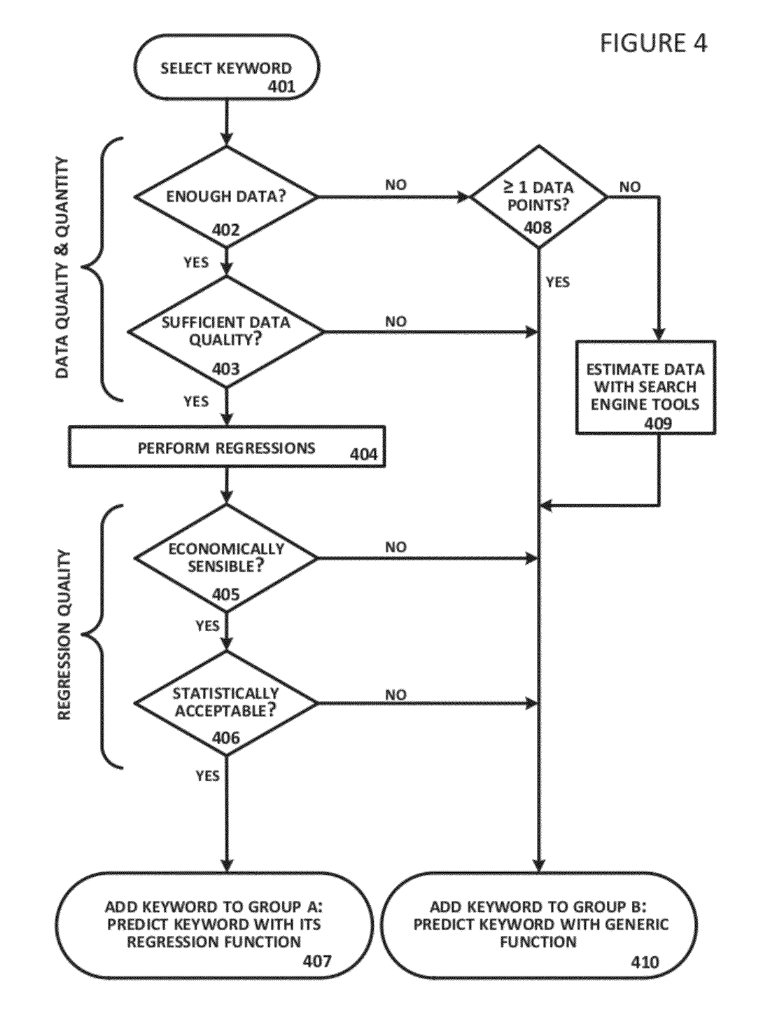

Second (as detailed in FIG. 4 and discussed in detail below), a portfolio keyword is classified to determine whether the quantity and quality of existing historical data are sufficient to generate one or more accurate prediction. If sufficient historical data exist for the keyword (i.e., enough data exist and are of good quality), future behavior of the keyword can be predicted using a function calculated by performing a regression on its historical data. If insufficient historical data exist for the portfolio keyword (i.e., not enough data exist, or if the data are not of good enough quality), future behavior of the keyword cannot be predicted using a function calculated by performing a regression on its historical data.

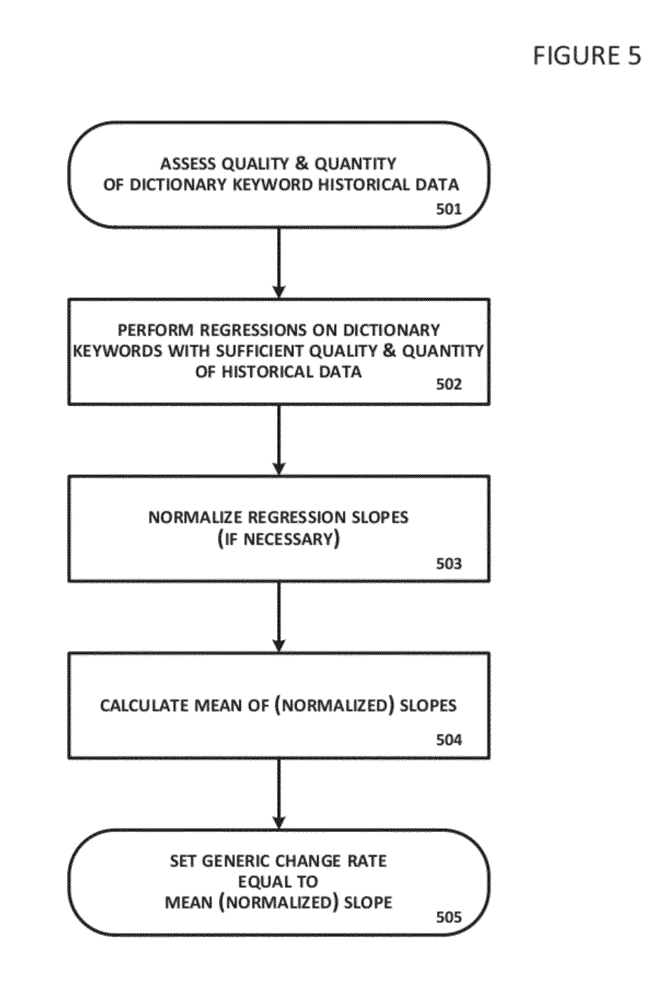

Third (as detailed in FIG. 5 and discussed in detail below), if insufficient historical data exist for the portfolio keyword, then a generic parameter (the “generic change rate”) is derived from a pool of prediction functions calculated Coca dictionary of keywords with sufficient historical data. In one embodiment, the dictionary of keywords can be stored in data store 305.

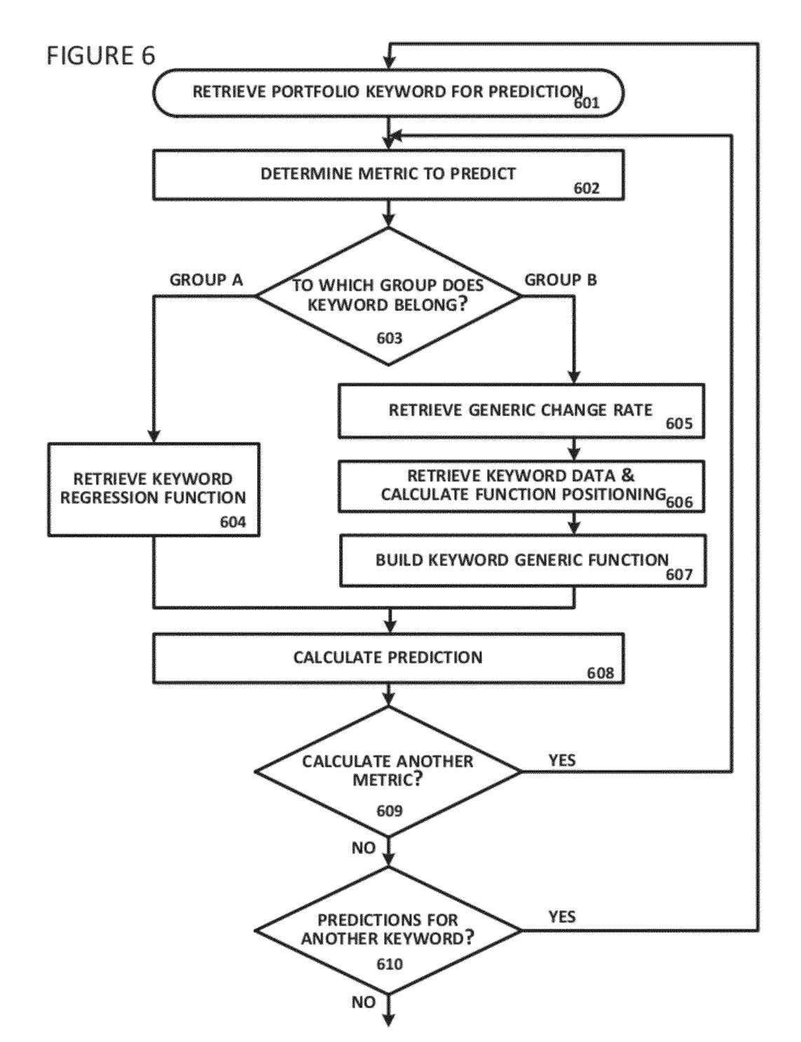

Finally, the generic change rate is used to compute a “generic function” for the portfolio keywords with insufficient historical data to predict future performance of the portfolio keywords (as detailed in FIG. 6 and discussed in detail below).

Keyword Classification. Computing system 304 performs a classification tree analysis on keywords within an advertising campaign portfolio to determine whether historical data of sufficient quantity and quality exist so that the historical data for that keyword can be used to predict the future performance of the keyword (e.g., clicks generated by the keyword and CPC per ad position) or whether the future performance of the keyword should be estimated through the use of a generic function. The result of the classification analysis is that any keyword with sufficient historical data to predict its future performance is assigned to group A, whereas any keyword lacking sufficient historical data to predict its own future performance is assigned to group B.

Each keyword undergoes this data validation through the classification tree on a regular basis, preferably daily. If the historical data analysis of a keyword is satisfactory (i.e., enough historical data of acceptable quality exist to predict how the keyword will perform in the future), the keyword is assigned to group A. Historical data (data for one or more pair of metrics X and Y) for a keyword in group A can be then used to determine the relationship of the type Y=f(X) between the metrics for that group A portfolio keyword. More specifically, the data for that keyword can be used to predict several metrics, including (for each ad position on a search engine):
average CPC;
maximum CPC;
clicks;
conversions;
impressions;
revenue; and/or
return on advertising spending (ROAS).
   The keyword data can also be used to predict, for example, clicks, conversions, revenue, and ROAS for the average CPC or maximum CPC,

If the historical data analysis for the keyword is not satisfactory (i.e., not enough historical data of acceptable quality exist to predict how the keyword will perform in the future), then the keyword is assigned to group B. Because historical data for keywords in group B is inadequate to generate accurate predictions about future keyword performance, a generic function is used instead to determine the relationship of the type Y=f(X) between the metrics.

One embodiment of this classification tree analysis is detailed in the flowchart of FIG. 4. In step 401, computing system 304 retrieves a keyword for analysis. The keyword may be retrieved from user input, from data store 305 containing one or more keyword, from an existing keyword portfolio stored locally, or remotely, or from system memory.

In step 402, computing system 304 determines whether the keyword has sufficient historical data within the last x days where x can be predefined or chosen by a system user (e.g., at least 90 days of data within the last 120 days). To do this, computing system 304 sums the number of days in the last x days that the keyword had at least one impression (i.e., a given advertiser's ad containing the keyword was displayed on a search engine results page) or click. If insufficient historical data exist to enable good predictions (e.g., if the above requirement of sufficient data within the last x days is not met), then computing system 304 determines, in step 408, whether any historical data exist. If no historical data exist, then in step 409, computing system 304 uses search engine tools known in the art (e.g., traffic tools such as Google AdWords™ Keyword Tool) to estimate data points. If, in step 408, some (albeit insufficient) historical data exist, or if, in step 409, estimated data are obtained from search engine tools, then, in step 410 (and as discussed in greater detail below), the keyword is assigned to group B which contains keywords for which a generic prediction function is to be used to predict future keyword performance (FIGS. 5 and 6, discussed in greater detail below).

If, in step 402, computing system 304 determines that sufficient historical data exist for the keyword, then in step 403, computing system 304 determines whether the sum of the clicks generated from that keyword in the last x days is greater than or equal to a predefined or user-defined threshold value (e.g., 20 clicks per day of available data, which would yield at least 1800 clicks if at least 90 days of data are required within the last 120 days). If the recent (within last x days) generated clicks are less than the user-defined threshold value, then in step 410 (and as discussed in greater detail below), the keyword is assigned to group B which contains portfolio keywords for which a generic prediction function is to be used to predict future keyword performance (FIGS. 5 and 6, discussed in greater detail below).

If computing system 304 determines, in step 403, that enough recent clicks have been generated for the keyword (i.e., generated clicks equal or exceed the user-defined threshold value), then, in step 404, one or more linear and/or exponential regression(s) is/are performed on key word data (e.g., clicks regressed on ad position, CPC regressed on ad position, conversions regressed on ad position, maximum CPC regressed on ad position, average CPC regressed on ad position, impressions regressed on ad position, revenue regressed on ad position, clicks regressed on maximum CPC, average CPC regressed on maximum CPC, and/or conversions regressed on maximum CPC). Specifically, computing system 304 regresses a dependent variable (e.g., clicks) on the independent variable (e.g., ad position) for the keyword. The regression can be linear (in which Y=intercept+(X*slope), where Y=the dependent variable and X=the independent variable) or non-linear e.g., exponential, in which Y=k*exp(c*X) where c and k are constants). Once a regression equation is determined for a given pair of variables (e.g., ad position and clicks), computing system 304 can feed data into the regression equations to assess the quality of the regressions and to generate predicted values of the dependent variable (e.g., clicks) from values of the independent variable (e.g., ad position).

In step 405, computing system 304 determines whether the predicted values obtained from the regression(s) performed in step 404 make sense economically in the domain of internet marketing. Because enough historical data exist, actual data can be input into the obtained regression equations to verify whether the obtained equations generate valid predictions. For example, computing system 304 can verify that:
the first ad position is well-predicted (i.e., that the predicted value of the dependent variable clicks) for the first ad position closely approximates the historical data for the first ad position);
the number of predicted clicks for ad position 1 is greater than 0;
the obtained ad position for a predicted maximum CPC or average CPC of $0 is greater than or equal to 1 (the lowest value of a position is 1, although position 1 is the most favorable position);
the derivative of a regression curve is negative or positive depending on the type of regression; and/or
the number of clicks or conversions, or the value of the maximum CPC, average CPC, or revenue is not over-estimated in ad position 1 (i.e., that the predicted values of these variables for ad position 1 are not substantially higher than the values for these variables for ad position 1 in the historical data).

If computing system 304 determines, in step 405, that the predictions for the keyword do not make sense economically (i.e., that the regression(s) do not yield reasonable predictions for internet marketing), then in step 410 (and as discussed in greater detail below), the keyword is assigned to group B which contains portfolio keywords for which the generic prediction function is to be used to predict future keyword performance (FIGS. 5 and 6, discussed in greater detail below).

If computing system 304 determines, in step 405, that the predictions for the keyword are economically sensible (i.e., that the regression(s) yield good predictions for internet marketing), then, in step 406, computing system 304 uses known statistical goodness-of-fit techniques to determine whether the quality of the regression curve(s) is/are statistically acceptable. Computing system 304 can use several criteria to make this determination, including (without limitation) whether:
the coefficient of determination exceeds a predetermined value (e.g., R² value≧0.30);
the function derivative is negative (i.e., the function is decreasing) or positive (i.e., the function is increasing) depending on the type of regression (e.g., the derivative of the regression function of average CPC on ad position is negative, whereas the derivative of the regression function of average CPC on maximum CPC is positive); and/or
the values predicted by the regression function are positive for at least the first p positions where p is a predefined value.
   If the regression curves are statistically acceptable, computing system 304 stores the regression curves in memory, local storage or remote storage.

If computing system 304 determines, in step 406, that the regression curves are not acceptable (i.e., do not pass goodness-of-fit analyses), then in step 410 (and as discussed in greater detail below), the keyword is assigned to group B which contains portfolio keywords for which the generic prediction function is to be used to predict future keyword performance (FIGS. 5 and 6, discussed in greater detail below).

If computing system 304 determines, in step 406, that the regression curves provide good fit predictions, then in step 407, the keyword is assigned to group A (containing keywords for which the future performance of each keyword can be predicted using the regression function(s) for that keyword). The keyword, its associated data; and its associated regressions are then passed to computing system 304 and stored in memory (or optionally stored in data store 305) for later access and inclusion in the data set used for keyword portfolio optimization.

Any portfolio keyword which does not pass data validation in step 402, 403, 405, or 406 does not have historical data of sufficient quantity or quality to be used for prediction of that keyword's future performance in an advertising campaign and is assigned to group B. Rather than eliminate the keyword from an advertising campaign, a generic function can be used to make predictions about that keyword's performance.

Calculation of Generic Change Rate. When adequate regressions can be obtained using historical data for a keyword, predicting clicks and cost per click as a function of position can be performed. A large proportion of keywords with adequate historical data, however, do not provide statistically acceptable regressions (i.e., the predictions from the regressions are not economically sensible (step 405) or are not good-fit predictions (step 406)). In those cases (as with keywords for which inadequate historical data exist), generic functions can be generated and substituted for predictions based on the historical data.

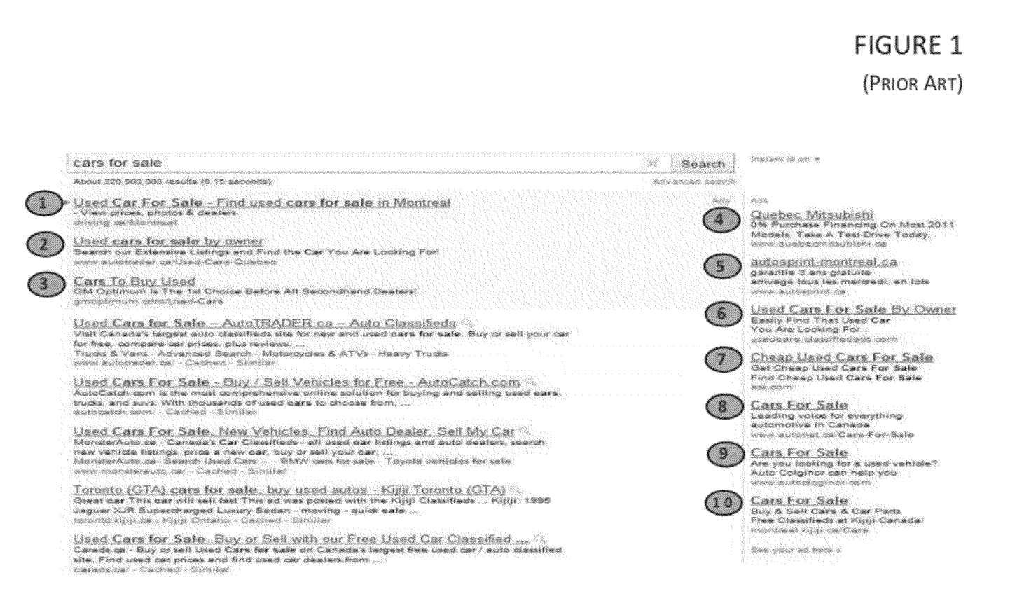

Text ad positions are standardized across search engines such that the ads are located within particular regions of a search results page regardless of the search engine or the search request (see FIG. 1). The potential ad positions remain standard even though the number of ads can vary from one search request to another and even though the generated ads can move from one position to another when the auctioned keyword values change. The generation and successful use of generic functions to predict keyword performance across these as positions rests on the belief that a negative correlation exists between the number of clicks produced by a keyword and its average position, as well as between the maximum and/or average CPC for a keyword and its average position. If clicks on ads tend to be distributed proportionally between each potential ad position such that the clicks tend to decrease (or increase) at the same relative rate between ad positions—regardless of the ad keyword(s)—then this near-constant decay (or acceleration) rate between ad positions can be exploited to predict dependent variables clicks, average CPC, maximum CPC, impressions, conversions, etc.) in the absence of historical data generally used for such predictions.

FIG. 5 details the steps involved in defining the near-constant decay or acceleration rate (i.e., the generic change rate) from regression analyses performed on keywords with sufficient acceptable historical data (i.e., the dictionary keywords). The keyword dictionary may, but need not, contain one or more keyword also contained within the group A portfolio keywords. As an example, the word “table” may have sufficient historical data to predict its future performance, and may be contained within the keyword dictionary, but may not be contained within the group A portfolio keywords, whereas “chair” may have sufficient historical data to predict its future performance, and may be contained within the dictionary of words, and may also be contained within the group A portfolio keywords designed for an advertising campaign.

In step 501, computing system 304 assesses the quality and quantity of historical data for dictionary keywords (retrieved from search engine server 303 and/or data store 305) the following criteria:
the standard deviation across the ad position values within x days exceeds a predefined value (e.g., ≧1.5 clicks across ad positions);
the difference between the maximal ad position value and the minimal ad position value within x days exceeds a predefined value (e.g., ≧4);
the number of days of available data exceeds a predefined value (e.g., ≧100 days of data within the last 120 days);
the mean number of clicks per day exceeds a predefined value (e.g., ≧20); and
the minimal position value is below a predefined value (e.g., at least one observation from ad positions 1 through 5 inclusively).

Keywords identified as having sufficient historical data of sufficient quality are then used by computing system 304 in the calculation of the generic change rate by the following process.

In step 502, computing system 304 performs one or more linear and/or exponential regression(s) on the keyword data for the dictionary keywords identified as having sufficient historical data of sufficient quality (e.g., clicks regressed on ad position, CPC regressed on ad position, conversions regressed on ad position, maximum CPC regressed on ad position, average CPC regressed on ad position, impressions regressed on ad position, revenue regressed on ad position, clicks regressed on maximum CPC, average CPC regressed on maximum CPC, and/or conversions regressed on maximum CPC). Specifically, computing system 304 regresses a dependent variable (e.g., clicks) on the independent variable (e.g., ad position) for the keyword. The regression can be linear (in which Y=intercept±(X*slope), where Y=the dependent variable and X=the independent variable) or non-linear (e.g., exponential, in which Y=k*exp(c*X) where c and k are constants). Once a regression equation is determined for a given pair of variables (e.g., ad position and clicks), computing system 304 can feed data into the regression equations to assess the quality of the regressions and to generate predicted values of the dependent variable (e.g., clicks) from values of the independent variable ad position). Computing system 304 uses known statistical goodness-of-fit techniques to determine whether the quality of the regression curve(s) is/are statistical acceptable. Computing system 304 can use several criteria to make this determination, including (without limitation) whether:
the coefficient of determination exceeds a predetermined value (e.g., R² value≧0.30);
the function derivative is negative (i.e., the function is decreasing) or positive (i.e., the function is increasing) depending on the type of regression (e.g., the derivative of the regression function of average CPC on ad position is negative, whereas the derivative of the regression function of average CPC on maximum CPC is positive); and/or
the values predicted by the regression function are positive for at least the first p ad positions where p is a predefined value.
   Keywords that do not achieve target values of the criteria are suppressed from the dictionary (i.e., not used in the computation of the generic change rate).

In step 503, if the performed keyword regression functions are linear, computing system 304 normalizes the regression slopes for those linear functions (by, for example, dividing the regression slope by the respective regression intercept). As is known in the art, if the regression is non-linear, the normalization of slope values is not necessary because the slope values obtained in the initial regressions are already expressed on a common normalized scale.

In step 504, outliers [defined as data values outside the interval delineated by the endpoints (median −3*inter-quartile range) and (median +3*inter-quartile range)] are discarded from the data set after each regression is performed. Computing system 304 then calculates the mean of the slope values (normalized if necessary) for the performed keyword regression functions.

In step 505, computing system 304 designates the mean (normalized if necessary) slope value as the generic change rate to be used as the change rate for the prediction functions of the portfolio keywords in group B. Computing system 304 then stores the generic change rate locally or remotely.

The generic change rate can be calculated using data for any or all keywords in the keyword dictionary, which may or may not include keywords from portfolio group A, In addition, the user can also direct that a subset of identified keywords be used to calculate the generic change rate. Once the generic change rate is calculated for the keyword, that generic change rate can be used to predict the dependent variable discussed herein for any keyword. Thus, the same generic change rate can be used to make predictions for any portfolio keyword in group B.

Making Keyword Predictions. Referring now to FIG. 6, the flowchart details how computing system 304 predicts metrics (e.g., maximum CPC, average CPC, clicks, and/or conversions as a function of position) for group A and group B portfolio keywords. These predictions ultimately provide estimations that can be used to determine optimal bid values in the global optimization model. The process outlined in FIG. 6 is performed for any desired metrics (e.g., maximum CPC vs. position, average CPC vs. position, clicks vs. position, natural logarithm of maximum CPC (“In(maximum CPC)”) vs. position, ln(average CPC) vs. position, ln(clicks) vs. position).

In step 601, computing system 304 retrieves the keyword to process for one or more prediction. The keyword can be retrieved from memory (e.g., a keyword which failed data verification step 402, 403, 405, or 406 in FIG. 4) or can be retrieved from a local or remote data store into which the keyword was stored following the data validation outlined in FIG. 4,

In step 602, computing system 304 determines which metric to predict (i.e., which variable to predict from which other variable). Specifically, computing system 304 determines which dependent variable (e.g., clicks, impressions, average CPC, maximum CPC, etc.) is to be predicted based on which independent variable (e.g., ad position). This determination can be based on user input data or can be automatic based on a predetermined schedule.

In step 603, computing system 304 determines the group to which the keyword belongs. If the keyword belongs to group A, then, in step 604, computing system 304 retrieves the best regression function for that keyword (based on the goodness-of-fit analyses such as those discussed in step 406, described above with respect to FIG. 4).

If the keyword belongs to group B, then computing system 304 builds the generic regression function for that keyword (steps 605, 606, and 607). In step 605, computing system 304 retrieves the generic change rate designated in step 505 (described above with respect to FIG. 5).

In step 606, computing system 304 retrieves the data associated with the keyword to determine how the generic function will be positioned. If two or more existing data points for the keyword are retrieved, then computing system 304 uses the existing historical data for the keyword to calculate the positioning of the generic function. More specifically, an historical average point is computed by determining an intersection of the mean value of the dependent variable (e.g., maximum CPC, average CPC, clicks, conversions) and the mean value of the independent variable (e.g., position, maximum (CPC). Computing system 304 uses this historical average point as a positioning parameter through which the generic function for the keyword must pass (discussed in greater detail below in step 607).

One of skill in the art will understand that historical data points used to calculate mean independent or dependent variable values (e.g., mean ad position, mean clicks, or mean CPC) can be assigned different weights to favor more recent observations and/or to control for effects of data skewed because user clicks on individual keywords can vary a great deal over a short time. This weighting can be achieved by applying exponentially decreasing weights to the data of the reference period, according to data seniority. As an example, the following formula can be used: weight_{for day j}=s^{x-j}, where s is a constant between 0 and 1, x is the length of the reference period and j is the day of the data point (j is between 0 and x).

If only one existing data point is retrieved, then computing system 304 uses that point as the positioning parameter (b if the function is linear of the type Y=a*X+b, k if the function is exponential of the type Y=k*exp(c*X)) through which the generic function for the keyword must pass.

If no actual data exist for the keyword, computing system 304 retrieves the estimated data point for the metrics of interest (estimated with search engine tools in step 409, discussed with respect to FIG. 4 above) and uses that estimated data point as the positioning parameter through which the generic function for the keyword must pass.

In step 607, computing system 304 builds the generic function for the keyword using the positioning parameter for that keyword and the retrieved generic change rate. The generic function can be a linear relationship of the type Y=a*X+b, where Y is the metric to be predicted (e.g., CPC), X is the known metric (e.g., ad position), a is the slope (substituted here by the generic change rate), and b is the y-intercept (substituted here by the positioning parameter). Or, the generic function can be an exponential relationship of the type Y=k*exp(c*X), where Y is the metric to be predicted (e.g., CPC), X is the known metric (e.g., ad position), c is a constant (substituted here by the generic change rate), and k is another constant (substituted here by the positioning parameter).

Once computing system 304 has retrieved the regression equation for the keyword (step 604) or built the generic regression function for the keyword (step 607), then, in step 608, computing system calculates predictions of future performance of that keyword with respect to one pair of metrics (e.g., CPC as a function of ad position). Examples of generic functions (number of clicks as a function of average ad position and average cost per click as a function of average ad position) generated from known data for specific keywords are presented in Appendix A. In each figure, calculated generic curves are shown by dashed lines and linearized exponential regressions on actual known data are plotted with solid lines. For each figure with a y-axis showing “Average CPC”, a comma is used to indicate a decimal point (e.g., 0.4 indicates 0.4). As can be seen in the figures, the generic function regression lines (dashed lines) closely match regression lines generated from known data (solid lines), indicating that the generic functions reliably yield valid predictions that can be used in the absence of real data.

In step 609, computing system 304 determines whether another prediction for the same keyword, but for another pair of metrics is needed. Computing system 304 can make this determination based on an automated schedule or based on user input. If another prediction for the keyword is to be calculated, then computing system 304 returns to step 602 of the process. This loop is continued until all requested or scheduled functions have been calculated.

If no additional metrics are to be calculated for the keyword being processed, then, in step 610, computing system 304 determines whether a prediction is needed for another keyword. Computing system 304 can make this determination based on an automated schedule or based on user input. If a prediction is needed for another keyword, then computing system 304 returns to step 601 and repeats the process for the new keyword. This loop continues until all requested or scheduled predictions for the keywords have been made.

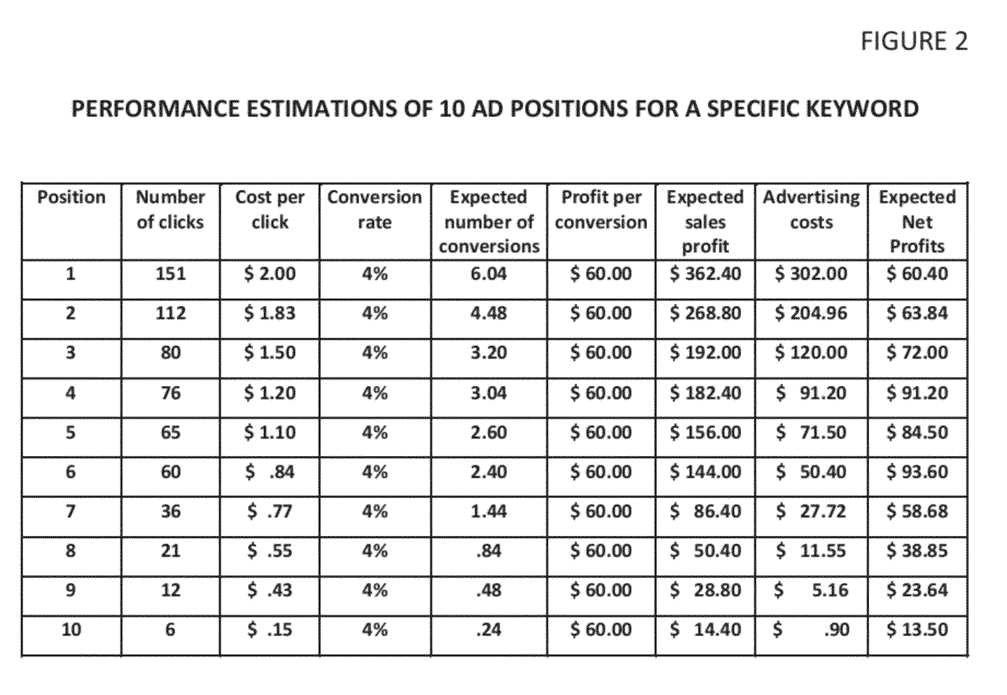

If no additional predictions are to be made, then the calculated functions for each keyword are used to optimize the keyword portfolio for the online advertising campaign. For example, a table such as that shown in FIG. 2 can be prepared for each keyword, and the most profitable keywords (e.g., lowest advertising cost and highest expected net profits) can be used in the advertising campaign,

Advertisers can create and optimize portfolios of keywords for different pay-per-click campaigns and for different search engines. If the advertiser chooses to create more than one portfolio, the portfolios are optimized separately with a separate budget for each. Advertisers can specify the cycle that keywords follow (i.e., how often a keyword goes through the classification tree and prediction process), to be daily (preferably), weekly, monthly, yearly, or on a user-specified cycle.

It is to be understood that the examples given are for illustrative purposes only and may be extended to other implementations and embodiments. While a number of embodiments are described, there is no intent to limit the disclosure to the embodiment(s) disclosed herein. On the contrary, the intent is to cover all alternatives, modifications, and equivalents apparent to those familiar with the art.

It is to be further understood that the embodiments discussed herein can all be implemented in software stored in a computer readable storage medium for access as needed to either run such software on the appropriate processing hardware.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method to predict performance of keywords in an interact pay-per-click advertising campaign comprising:
receiving at a computing system a portfolio of keywords from a user computing device across a network;
receiving at the computing system prior performance data for keywords in the portfolio;
identifying a first set of portfolio keywords lacking sufficient prior performance data to be able to predict future performance of the first set of portfolio keywords;
accessing at the computing system a dictionary of keywords and prior performance data for keywords in the dictionary, each dictionary keyword having sufficient prior performance data to be able to predict future performance of the dictionary keyword;
generating prediction functions based on the accessed dictionary of keywords with sufficient prior performance data, each prediction function having a change rate;
predicting the performance of the first set of portfolio keywords lacking sufficient prior performance data, the performance prediction being based on the change rates of the prediction functions for the accessed dictionary of keywords with sufficient prior performance data; and
transmitting the performance prediction across the network to the user computing device.

2. The method of claim 1 further comprising:
identifying a second set of portfolio keywords having sufficient prior performance data to be able to predict future performance of the second set of portfolio keywords;
generating prediction functions based on the second set of portfolio keywords with sufficient prior performance data;
predicting the performance of one or more keyword in the second set of portfolio keywords with sufficient prior performance data, the performance prediction being based on the prediction functions for the one or more keyword in the second set of portfolio keywords with sufficient prior performance data; and
transmitting the performance prediction for the one or more keyword across the network to the user computing device.

3. The method of claim 2 further comprising:
optimizing the interact pay-per-click advertising campaign based on the performance prediction for the first set of portfolio keywords and the performance prediction for the one or more keyword from the second set of portfolio keywords; and
transmitting the optimized internet pay-per-click advertising campaign across the network to the user computing device.

4. The method of claim 1 wherein the first set of portfolio keywords contains one or more portfolio keyword.

5. The method of claim 4 wherein the performance prediction is further based on a positioning parameter determined from the first set of portfolio keywords lacking sufficient prior performance data.

6. The method of claim 1 wherein the performance prediction is a maximum cost per user click on an advertisement containing the other portfolio keyword,

7. The method of claim 1 wherein the performance prediction is an average cost per user click on an advertisement containing the other portfolio keyword, a number of user clicks on the advertisement containing the other portfolio keyword, a number of conversions, a number of impressions, revenue, or return-on-advertising spending.

8. The method of claim 1 wherein the predicted performance is A predicted from B, wherein A is a maximum cost per user click on an advertisement containing one portfolio keyword from the second set and B is a position on an interact search results page of the advertisement containing the one portfolio keyword from the second set.

9. The method of claim 1 wherein the predicted performance is A predicted from B, wherein A is an average cost per user click on an advertisement containing one portfolio keyword from the second set and B is a position on an interact search results page of the advertisement containing the one portfolio keyword from the second set.

10. The method of claim 1 wherein each of the prediction functions predicts C from D, wherein C is a maximum cost per user click on an advertisement containing one portfolio keyword from the first set and D is a position on an internet search results page of the advertisement containing the one portfolio keyword from the first set.

11. The method of claim 1 wherein each of the prediction functions predicts C from D, wherein C is an average cost per user click on an advertisement containing one portfolio keyword from the first set and D is a position on an internet search results page of the advertisement containing the one portfolio keyword from the first set.

12. The method of claim 1 wherein the change rate is a slope of the prediction function.

13. The method of claim 12 wherein the performance prediction is based on the averaged change rates from two or more prediction functions.

14. The method of claim 13 wherein the performance prediction is further based on an intersection of C and D wherein C is the average cost per user click on the advertisement containing one portfolio keyword from the second set averaged across all positions on the internet search results page of the advertisement containing the one portfolio keyword and D is the position on the internet search results page of the advertisement containing the one portfolio keyword from the second set averaged across the average cost per user click on the advertisement containing the one portfolio keyword from the second set.

15. The method of claim 13 wherein the performance prediction is further based on an intersection C and D wherein C is the maximum cost per user click on the advertisement containing one portfolio keyword from the second set averaged across all positions on the internet search results page of the advertisement containing the one portfolio keyword and D is the position on the internet search results page of the advertisement containing the one portfolio keyword from the second set averaged across the maximum cost per user click on the advertisement containing the one portfolio keyword from the second set.

16. A system for predicting keyword performance in an internet pay-per-click advertising campaign comprising:
a computing system configured to
communicate over a network with a user computing device to obtain a keyword portfolio;
communicate over the network to obtain past performance data for the keywords in the portfolio;
identify a first set of portfolio keywords lacking sufficient prior performance data to be able to predict future performance of the first set of portfolio keywords;
access a dictionary of keywords and prior performance data for the keywords in the dictionary, each dictionary keyword having sufficient prior performance data to be able to predict future performance of the dictionary keyword;
generate prediction functions based on the accessed dictionary of portfolio keywords with sufficient prior performance data, each prediction function having a change rate;
predict the performance of the first set of portfolio keywords lacking sufficient prior performance data, the performance prediction being based on the change rates of the prediction functions for the accessed dictionary of keywords with sufficient prior performance data; and
transmit the performance prediction across the network to the user computing device.

17. The system of claim 16 wherein the computing system is further configured to
identify a second set of portfolio keywords having sufficient prior performance data to be able to predict future performance of the second set of portfolio keywords;
generate prediction functions based on the second set of portfolio keywords with sufficient prior performance data;
predict the performance of the second set of portfolio keywords with sufficient prior performance data, the performance prediction being based on the prediction functions for the second set of portfolio keywords with sufficient prior performance data; and
transmit the performance prediction for the one or more keyword across the network to the user computing device.

18. A non-transitory computer readable medium having stored thereupon computing instructions comprising:
a code segment to receive at a computing system a portfolio of keywords from a user computing device across a network;
a code segment to receive at the computing system prior performance data for keywords in the portfolio;
a code segment to identify a first set of portfolio keywords lacking sufficient prior performance data to be able to predict future performance of the first set of portfolio keywords;
a code segment to access at the computing system a dictionary of keywords and prior performance data for the keywords in the dictionary, each dictionary keyword having sufficient prior performance data to be able to predict future performance of the dictionary keyword;
a code segment to generate prediction functions based on the accessed dictionary of portfolio keywords with sufficient prior performance data, each prediction function having a change rate;
a code segment to predict the performance of the first set of portfolio keywords lacking sufficient prior performance data, the performance prediction being based on the change rates of the prediction functions for the accessed dictionary of keywords with sufficient prior performance data; and
a code segment to transmit the performance prediction across the network to the user computing device.

19. The non-transitory computer readable medium of claim 18 further having stored thereupon computing instructions comprising:
a code segment to identify a second set of portfolio keywords having sufficient performance data to be able to predict future performance of the second set of portfolio keywords;
a code segment to generate prediction functions based on the second set of portfolio keywords with sufficient prior performance data;
a code segment to predict the performance of the second set of portfolio keywords with sufficient prior performance data, the performance prediction being based on the prediction functions for the second set of portfolio keywords with sufficient prior performance data; and
a code segment to transmit the performance prediction for the one or more keyword across the network to the user computing device.
